(19) United States
(12) Patent Application Publication
(10) Pub. No.: US 2026/0316519 A1
(43) Pub. Date: Oct. 15, 2026

(54) Centrifugal Fan for an Air Conditioner

(71) Applicant: MAHLE International GmbH, Stuttgart (DE)

(72) Inventors: Christof BACHER, Ditzingen (DE); Ferdinand SEEL, Esslingen am Neckar (DE)

(21) Appl. No.: 19/467,901

(22) Filed: Feb. 3, 2026

(30) Foreign Application Priority Data
Feb. 4, 2025 (DE) 102025103968.2

(51) Int. Cl. B60H 1/00

(52) U.S. Cl. CPC B60H 1/00521

(57) ABSTRACT

A centrifugal fan for generating an airflow for an air conditioner for a vehicle interior is provided, wherein the centrifugal fan has an impeller that rotates about a rotational axis and a housing for the impeller, the housing has an axial intake channel (12) leading to the impeller, the housing has a deflection chamber encircling the rotational axis at a distance thereto, encompassing the impeller along the circumference, the housing has an axial outlet channel encircling the rotational axis at a distance thereto, axially adjacent to the deflection chamber, the intake channel is upstream of the impeller and the deflection chamber is upstream of the outlet channel, the impeller is upstream of the deflection chamber such that when the centrifugal fan is in use, an airflow is propelled radially into the deflection chamber by the impeller, and flows from the deflection chamber into the outlet channel.

The airflow can be homogenized in that the outlet channel is radially delimited on the outside by a circumferential outer wall and on the inside by a circumferential inner wall, and in that the inner wall has numerous successive deflecting edges on a downstream side facing away from the deflection chamber over its circumference, which are slanted in relation to the circumferential direction.

### CROSS-REFERENCE TO RELATED APPLICATIONS

This application claims priority from German Patent Application No. DE 102025103968.2, filed on Feb. 4, 2025, the entirety of which is hereby incorporated by reference herein.

The present invention relates to a centrifugal fan for generating an airflow for an air conditioner for a vehicle interior. The invention also relates to an air conditioner with such a centrifugal fan.

Fans are needed in air conditioners for vehicles for generating an air-conditioned airflow in the vehicle where the driver (male, female, other) and/or passengers (male, female, other) are located. The fan can be a centrifugal fan with an axial intake and axial outlet to obtain a particularly compact structure with an impeller and a deflection chamber between the intake and outlet. The airflow is deflected 90° twice in the housing. In the transition between the deflection chamber and the outlet, the airflow normally has a circular cross section, resulting an inhomogeneous distribution over its cross section at the outlet. Specifically, there is a stronger flow on the outer periphery of the airflow encircling a weaker center. This inhomogeneous flow at the outlet continues through the air conditioner, such that it flows unevenly through the various components in the air conditioner through which air can flow. These components include a filter, cooler, and heater. The uneven flow reduces the efficiency of the air conditioner and its components, and increases pressures therein.

The present invention addresses the problem of creating a better design for such a centrifugal fan, in particular with a better airflow. Specifically, the unevenness of the airflow through the components of the air conditioner is to be reduced.

This problem is solved with the invention by the subject matter of the independent Numbered Paragraph. Advantageous embodiments are the subject matter of the dependent Numbered Paragraphs.

The invention is based on the idea of delimiting the radially interior surface of the outlet with a circumferential inner wall with numerous deflecting edges distributed over its circumference that are slanted in relation to the circumferential direction. These deflecting edges can be elongated and slanted over their length in relation to the circumferential direction. The deflecting edges can be straight, curved, or undulating. A coherent flow off of the turbulent eddy structures is reduced by these slanted deflecting edges, reducing the noise caused by the interaction between them and the eddies. In addition, these slanted deflecting edges result in coherent longitudinal eddies, like those obtained with a vortex generator or eddy generator. This eddy generates a radially inward airflow below the deflecting edges. By broadening or widening the airflow radially inward, a more homogenous speed distribution is obtained over the entire cross section. In other words, the deflecting edges homogenize the airflow through the components of the air conditioner.

In detail, a centrifugal fan with an impeller that rotates about a rotational axis is proposed, with a housing for the impeller that has an axial intake channel leading inward to the impeller. The housing also has a deflection chamber encircling the rotational axis at a distance thereto. The housing also has an axial outlet channel encircling the rotational axis at a distance thereto, which is axially adjacent to the deflection chamber. The intake channel is upstream of the impeller. The deflection chamber is upstream of the outlet channel. The impeller is upstream of the deflection chamber, such that when the centrifugal fan is in use, the air flows radially into the deflection chamber and from there into the outlet channel. The outlet channel is delimited on the outside by an outer wall and on the inside by an inner wall. The inner wall has numerous deflecting edges distributed over its circumference on the side facing away from the deflection chamber, which are slanted in relation to the circumferential direction.

Numerous guide blades can be distributed over the circumference on the inside of the outlet channel, each of which has a leading edge facing toward the deflection chamber and a trailing edge facing away therefrom. Each blade extends from the inner wall to the outer wall. Each guide blade can have a dedicated deflecting edge, with each deflecting edge starting between the trailing edges of two adjacent guide blades and ending near one of the trailing edges. The airflow twists around the rotational axis in the deflection chamber due to the rotation of the impeller, which causes radially outward compression of the airflow due to the inertia forces. The guide blades are configured to deflect the airflow axially away from the circumferential direction. This significantly reduces the twisting of the airflow, consequently reducing the inertia forces, thus contributing to the homogenization of the airflow. By aligning the deflecting edges with the guide blades, the homogenizing effect of the deflecting edges can be improved.

In the present context, a “configuration” is the same as a “design,” and/or “arrangement,” such that “configured such that” means the same as “designed such that,” and/or “arranged such that.”

The various deflecting edges can extend along the circumference from a leading edge of a respective guide blade to the trailing edge thereof. This places the deflecting edge where the highest flow speeds are generated by the guide blades, which is where particularly strong eddies are formed when flowing over the deflecting edges.

The deflecting edges can be slanted less than 90° in relation to the circumferential direction, connecting the leading edges to the outer edges of the guide blades along the inner wall in a straight line. Consequently, the deflecting edges are slanted in the same direction as the guide blades in relation to the airflow. This effectively improves eddy formation at the deflecting edge.

The trailing edges of the guide blades ideally lie in a uniform downstream plane, at least on the inner wall. The inner wall can have an axial projection for each deflecting edge at its downstream side, which protrudes axially near the respective trailing edge beyond this downstream plane in the airflow direction, forming at least an end of the respective deflecting edge. In other words, the downstream side of the inner wall is no longer entirely in the downstream plane, but instead has projections forming the deflecting edges, which protrude axially beyond the downstream plane in the direction of the airflow. These projections allow for larger or longer deflecting edges to be obtained, improving the desired effect of eddy formation with which the airflow is deflected radially inward.

These projections can be triangular, with the corner facing away from the downstream plane preferably being rounded. These rounded corners prevent undesired noises. The triangular shape of the projections results in relatively large deflecting edges with a geometrically simple structure.

These projections can extend on both sides of the respective trailing edges. Consequently, the respective guide blades are surrounded on all sides at their trailing edges by the respective projections. This configuration has proven to be particularly good at generating eddies in the airflows near the trailing edges, where they are particularly fast.

There can be an axial indentation for each deflecting edge on the downstream side of the inner wall, forming the start of each deflecting edge between the trailing edges of adjacent guide blades, axially behind the downstream plane, thus behind the upstream side and forming a starting section of the respective deflecting edge. In this case, each deflecting edge is formed by a starting section of the respective indentation, and an end section of the respective projection. This results in a smooth transition between the starting sections and end sections of the respective deflecting edges. A particularly long or large deflecting edge can be obtained with these indentations, contributing to the desired eddy formation, and thus to the radial inward deflection of the airflow.

The indentations can be triangular with a rounded corner facing away from the downstream plane, e.g. to prevent undesired noise. The triangular design also contributes to a geometrically simple formation of the largest or longest possible deflecting edge.

The trailing edges of the guide blades can lie in a downstream plane, at least on the inner wall. The axial length of the deflecting edges can be between 40% and 60% of the axial spacing between the upstream plane and the downstream plane. Calculations by the inventor have indicated that with this coordination of the sizes, the deflecting edges can be particularly large or long, resulting in the desired eddy formation and the associated deflection of the airflow to obtain a clear homogenization thereof.

The projections can advantageously extend over between 25% and 35% of the axial spacing. Specifically, these projections can extend over exactly or approximately 30% of the axial spacing. The indentations can extend axially over between 20% and 30% of the axial spacing. Specifically, the indentations can extend over exactly or approximately 25% of the axial spacing. A configuration in which the projections extend over more of the axial spacing than the indentations has proven to be particularly advantageous. This coordination of the guide blades, projections and indentations results in a particularly effective eddy formation.

The inner wall can be serrated on the downstream side, with rising and falling edges. The rising edges form the deflecting edges. Each deflecting edge is thus formed by a rising edge of the serration. A design in which the falling edges are steeper than the rising edges has proven to be particularly effective. This results in longer rising edges than falling edges over the circumference. Consequently, the falling edges extend toward the respective guide blades where the airflow is slower, which is where the deflecting edge has a much lower effect. Consequently, effective use can be made of the structural space on the downstream side of the inner wall.

Each projection can form a rising edge and an adjacent falling edge at the downstream side of the downstream plane. Each indentation can also form a rising edge and an adjacent falling edge at the upstream side of the downstream plane. In other words, the projections and indentations are configured and aligned with each other such that they form the aforementioned serrated edge.

The deflecting edges can extend along a cylindrical surface that is concentric to the rotational axis. This results in an inner wall with the deflecting edges formed thereon that can be easily produced.

These deflecting edges can also be formed along a conical surface that is concentric to the rotational axis, which become narrower or wider further away from the deflection chamber. This further contributes to eddy formation.

The deflecting edges can be straight, curved, or undulating in an axial projection along the circumference, and/or in a radial projection. Disruptive interactions with the airflow, which could result in undesired noise, can be prevented by this.

The air conditioner obtained with the invention is designed to air-condition a vehicle interior with an air-conditioned airflow. The air conditioner has a channel for the air-conditioned airflow, and a centrifugal fan of the type described above. The centrifugal fan is at the intake end of the channel, such that the air discharged from the centrifugal fan conducts the airflow into this channel.

Other features and advantages of the invention can be derived from the dependent claims, drawings, and descriptions of the drawings.

The features specified above and described below can be used not only in the given combinations, but also in other combinations or in and of themselves, without abandoning the framework of the invention defined in the claims. Parts of a higher-order unit, such as a configuration, device, or assembly, that are indicated separately, can form separate parts or components of this unit, or be integral parts thereof, even if the drawings indicate otherwise.

Preferred exemplary embodiments of the invention are shown in the drawings, and shall be explained in greater detail below, in which the same reference symbols are used for the same, similar, or functionally identical components.

Therein, schematically:

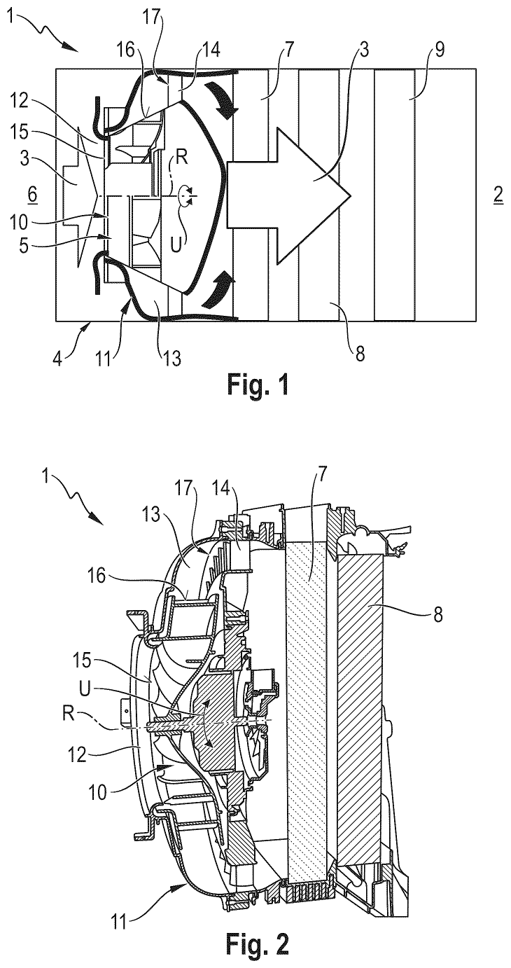

FIG. 1 shows a highly simplified illustration of an air conditioner with a centrifugal fan;

FIG. 2 shows a highly simplified isometric longitudinal cut through the air conditioner where the centrifugal fan is located;

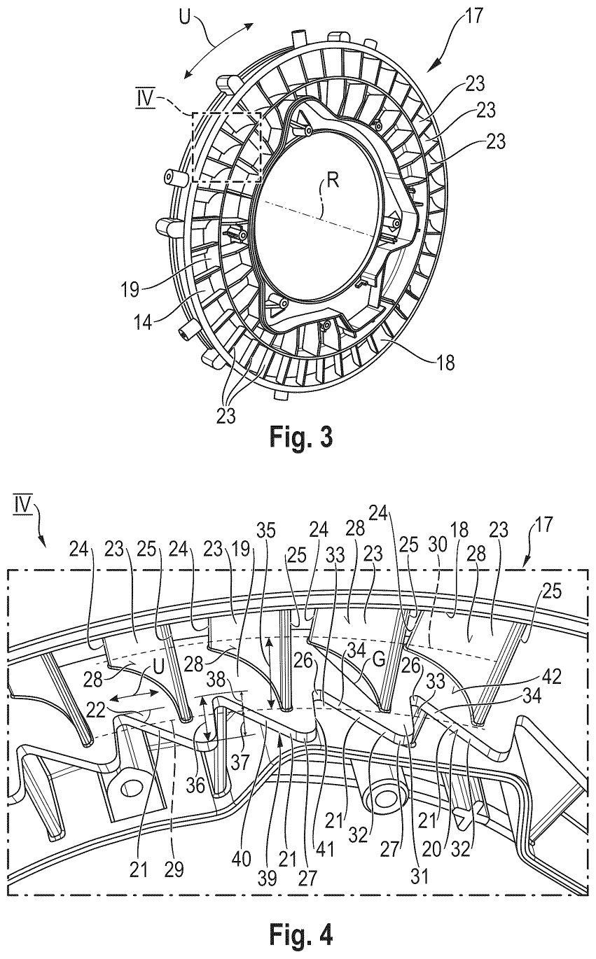

FIG. 3 shows an isometrical view of a flow guidance disk forming an outlet channel; and

FIG. 4 shows an enlargement of a detail IV in FIG. 3, but in a different orientation.

As shown in FIG. 1, an air conditioner 1 for a vehicle interior 2 contains a channel 4 for the airflow 3 and a centrifugal fan 5 for generating and propelling the airflow 3. When the centrifugal fan 5, or the air conditioner 1, is in use, the centrifugal fan 5 draws the airflow 3 from outside 6 the vehicle and/or the interior 2 thereof, and conducts it into the air channel 4. The air conditioner 1 can contain a filter 7 in the air channel 4 for the airflow 3, as well as a cooler 8 and a heater 9 for the airflow 3. By cooling and/or heating the airflow, the desired air-conditioning is obtained.

As shown in FIGS. 1 and 2, the centrifugal fan 5 has an impeller 10 that rotates about a rotational axis R. The rotational axis R defines an axial direction that is parallel to the rotational axis R. The rotational axis R also defines a radial direction that is perpendicular to the rotational axis R. The rotational axis R also defines a circumferential direction U encircling the rotational axis R.

The centrifugal fan 5 also has a housing 11 that contains the impeller 10 such that it can rotate therein. The housing 11 has an axial intake channel 12, a deflection chamber 13, and an axial outlet channel 14. The intake channel 12 conducts the airflow 3 to the impeller 10. The deflection chamber 13 forms a complete circle in the circumferential direction U, and is at a distance to the rotational axis R. The deflection chamber 13 encompasses the impeller 10 along the circumferential direction U. The outlet channel 14 forms a circle in the circumferential direction U at a distance to the rotational axis R, and is also axially adjacent to the deflection chamber 13. The deflection chamber 13 and/or outlet chamber 14 can be circular or in the shape of an oval.

The airflow 3 obtained when the centrifugal fan 5 is in use flows in the direction indicated by the arrow in FIG. 1. In this direction, the intake channel 12 is upstream of the impeller 10, and the deflection chamber 13 is upstream of the outlet channel 14. The impeller 10 is upstream of the deflection chamber 13. When the centrifugal fan 5 is in use, the impeller propels the airflow 3, such that it is drawn in axially by the intake channel and forced radially into the deflection chamber 13, where it is redirected into the outlet channel 14. The impeller 10 has an axial intake end 15 and a radial outlet end 16.

There is a flow guidance disk 17 in the centrifugal fan 5 in this design, creating the outlet channel 14, which is incorporated in the housing 11 and shown separately in FIG. 3. FIG. 4 shows a detail IV of FIG. 3, containing the flow guidance disk 17 in the outlet channel 14. As shown in FIGS. 2 to 4, the outlet channel 14 has a circumferential outer wall 18 and a circumferential inner wall 19. The inner wall 19 and outer wall 18 are concentric to one another and the rotational axis R. The outer wall 18 and/or inner wall 19 can be circular or oval. The outlet channel 14 is delimited on the outside by the outer wall 18 and on the inside by the inner wall 19. The inner wall has a downstream side 20 facing away from the deflection chamber 13, which faces toward the viewer in FIG. 4, and numerous deflecting edges 21 along the circumference U, which are slanted in relation to the circumferential direction U. The deflecting edges 21 are elongated. These deflecting edges 21 are slanted over their lengths in relation to the circumferential direction U. The deflecting edges 21 can be straight, curved, or undulating. These deflecting edges 21 are not shown in FIGS. 2 and 3. The angle of inclination 22 for these deflecting edges 21 in relation to the circumferential direction U is shown instead in FIG. 4. Purely by way of example, this angle of inclination 22 can be approx. 45°. As a rule, this angle of inclination 22 can be between 30° and 60°.

In this embodiment, the flow guidance disk 17 has numerous guide blades 23 in the outlet channel 14. The guide blades 23 are distributed over the circumference U and each have a leading edge 24 facing the deflection chamber 13 and a trailing edge 25 facing away therefrom. Ideally, there are the same number of deflecting edges 21 as guide blades 23. Consequently, each guide blade 23 has exactly one dedicated deflecting edge 21. The positioning or placement of the deflecting edges 21 is such that each deflecting edge 21 starts between the trailing edges 25 of adjacent guide blades 23, and ends between the trailing edges 25 thereof. Purely by way of example, the start 26 of a deflecting edge 26 is indicated in FIG. 4, which is between the two trailing edges 25 of adjacent guide blades 23 along the circumference U. The end 27 of the deflecting edge 21 is also indicated, which is near one of the two trailing edges 25 along the circumference U.

The guide blades 23 each have an upstream side 28. This upstream side 28 is facing toward the viewer in FIG. 4. The guide blade 23 has a concave curvature on the upstream side 28. The respective deflecting edge 21 preferably extends in the circumferential direction U along the upstream side 28 of the respective guide blade 23 to the trailing edge 25 thereof. This is when looking at an axial projection of the respective deflecting edge 21. FIG. 4 also shows that this deflecting edge 21 is slanted less than 90° in relation to the circumferential direction U, along a straight line G, which connects the leading edge 24 to the trailing edge 25 of the guide blade 23 on the inner wall 19. In FIG. 4, both the straight line G and the deflecting edge 21 are slanted less than 90° in relation to the circumferential direction U in the clockwise direction.

The trailing edges 25 of the guide blades 23 lie in a downstream plane 29, indicated with broken lines in FIG. 4, at least on the inner wall 19. Similarly, the leading edges 24 of the guide blades 23 lie in a upstream plane 30, also indicated with broken lines in FIG. 4, at least on the inner wall 19. The inner wall 19 has an axial projection 31 on its downstream side 20 for each deflecting edge 21, which extends axially over the downstream plane 29 near the respective trailing edge 20, forming at least an end section 32 of the respective deflecting edge 21. These projections 31 protrude over the downstream plane 29 in the direction of the airflow. The projections are triangular, as shown in this example. The corner pointing away from the downstream plane 29 can be rounded. This rounded corner is at the end 27 of the edge. The projections 31 are sized and placed such that they extend on both sides of the trailing edges 25 along the circumference U. In this case, the projections are seen from an axial perspective.

The inner wall 19 can also have an axial indentation 33 on its downstream side 20 for each deflecting edge 21, which is between the two trailing edges 25 of two adjacent guide blades 23, axially behind the downstream plane 29, thus behind the upstream side and forming a starting section 34 of the respective deflecting edge 21. In this example, the deflecting edges 21 are formed by the starting sections 34 of the indentations 33 and the end sections 32 of the projections 31. The indentations 33 can also be triangular. The corner facing away from the downstream plane 29 can also be rounded. This rounded corner is at the start 26 of the respective deflecting edge 21.

The upstream plane 30 is at an axial spacing 35 to the downstream plane 29, which defines 100%. The deflecting edges 21 have an axial length 36 from the start 26 to the end 27 that is shorter than the axial spacing 35. This axial length 36 is preferably 40% to 60% of the axial spacing 35. Specifically, the axial length 36 is greater than 50% of the axial spacing 35. The projections 31 can have an axial height 37 that is 25% to 35%, preferably approximately 30% of the axial spacing 35. The indentations 33 have an axial depth of 20% to 30%, preferably approximately 25% of the axial spacing 35. The height 37 of the projection 31 is preferably greater than the depth 38 of the indentation 33. Specifically, the projection 31 is therefore larger than the indentation 33.

As FIG. 4 shows, the inner wall 19 has a serrated edge 39 on its downstream side 20. The serrated edge 39 has alternating rising edges 40 and falling edges 41 over the circumference U. The rising edges 40 form the deflecting edges 21. The falling edges 41 can be steeper than rising edges 40 in relation to the circumferential direction U. Consequently, the falling edges 41 are much shorter than the rising edges 40.

The projections 31 and associated indentations 33 thus form the serrated edge 39. Each projection 31 forms a rising edge 41 and an adjacent falling edge 41 of the section in front of and downstream the downstream plane 29. Furthermore, each indentation 33 forms a rising edge 40 and an adjacent falling edge 41 of the section behind and upstream of the downstream plane 29.

The inner wall 19 extends along a cylindrical surface 42 that is concentric to the rotational axis R in this preferred embodiment. The deflecting edges 21 extend along this cylindrical surface 42. The deflecting edges are also formed substantially by straight lines.

The specification can be readily understood with reference to the following Numbered Paragraphs:
Numbered Paragraph 1. A centrifugal fan (5) for generating an airflow (3) for an air conditioner (1) for a vehicle interior (2), wherein
   the centrifugal fan (5) has an impeller (10) that rotates about a rotational axis (R) and a housing (11) for the impeller (10),
   the housing (11) has an axial intake channel (12) leading to the impeller (10),
   the housing (11) has a deflection chamber (13) encircling the rotational axis (R) at a distance thereto, encompassing the impeller (10) along the circumference (U),
   the housing (11) has an axial outlet channel (14) encircling the rotational axis (R) at a distance thereto, axially adjacent to the deflection chamber (13),
   the intake channel (12) is upstream of the impeller (10) and the deflection chamber (13) is upstream of the outlet channel (14),
   the impeller (10) is upstream of the deflection chamber (13) such that when the centrifugal fan (5) is in use, an airflow (5) is propelled radially into the deflection chamber (13) by the impeller (10), and flows from the deflection chamber (13) into the outlet channel (14),
   the outlet channel (14) is delimited on the outside by a circumferential outer wall (18) and on the inside by a circumferential inner wall (19),
   the inner wall (19) has numerous deflecting edges (21) along the circumference (U) on the downstream side (20) facing away from the deflection chamber (13), which are slanted in relation to the circumferential direction (U).
Numbered Paragraph 2. The centrifugal fan (5) according to Numbered Paragraph 1, characterized in that
   there are numerous guide blades (23) in the outlet channel (14) along the circumference (U), each of which has a leading edge (24) facing the deflection chamber (13) and a trailing edge (25) facing away from the deflection chamber (13),
   each guide blade (23) has a dedicated deflection edge (21),
   the deflection edges (21) start between the two trailing edges (25) of adjacent guide blades (23) and end near one of these trailing edges (25).
Numbered Paragraph 3. The centrifugal fan (5) according to Numbered Paragraph 2, characterized in that the deflecting edges (21) extend to the trailing edges (25) of their respective guide blades (23) in the circumferential direction (U) along the upstream side (28) thereof.
Numbered Paragraph 4. The centrifugal fan (5) according to Numbered Paragraph 2 or 3, characterized in that the deflecting edges (21) are slanted in relation to the circumferential direction (U) in the direction of a straight line (G) that connects the leading edge (24) to the trailing edge (25) of the respective guide blade (23) on the inner wall (19).
Numbered Paragraph 5. The centrifugal fan (5) according to any of the Numbered Paragraphs 2 to 4, characterized in that
   the trailing edges (25) of the guide blades (23) lie in a downstream plane (29), at least on the inner wall (19),
   the inner wall (19) has an axial projection (31) for each deflecting edge (21) on its downstream side (20), which protrudes axially over the downstream plane (29) near the respective trailing edge (25), and forms at least an end section (32) of the respective deflecting edge (21).
Numbered Paragraph 6. The centrifugal fan (5) according to Numbered Paragraph 5, characterized in that the projections (31) are triangular, wherein the corner axially spaced apart from the downstream plane (29) is rounded.
Numbered Paragraph 7. The centrifugal fan (5) according to Numbered Paragraph 5 or 6, characterized in that the projections (31) extend on both sides of the trailing edges (25) along the circumference (U).
Numbered Paragraph 8. The centrifugal fan (5) according to any of the Numbered Paragraphs 5 to 7, characterized in that
   the inner wall (19) has an axial indentation (33) for each deflecting edge (21) on its downstream side (20), which is between the two trailing edges (25) of two adjacent guide blades (23), axially behind the downstream plane (29), and forming a starting section (24) of the respective deflecting edge (21),
   the deflecting edges (21) are formed by the starting sections (34) of the indentations (33) and the end sections (32) of the projections (31).
Numbered Paragraph 9. The centrifugal fan (5) according to Numbered Paragraph 8, characterized in that the indentations (33) are triangular, wherein the corner axially spaced apart from the downstream plane (29) is rounded.
Numbered Paragraph 10. The centrifugal fan (5) according to any of the Numbered Paragraphs 2 to 9, characterized in that
   the leading edges (24) of the guide blades (23) lie in a upstream plane (30), at least on the inner wall (19),
   the axial length (36) of the deflecting edges (21) is 40% to 60% of the axial spacing (35) between the upstream plane (30) and the downstream plane (29).
Numbered Paragraph 11. The centrifugal fan (5) according to Numbered Paragraph 10, and according to Numbered Paragraph 8 or 9, characterized in that
   the axial extension of the projections (31) is 25% to 35% of the axial spacing (35),
   the axial extension of the indentations (33) is 20% to 30% of the axial spacing.
Numbered Paragraph 12. The centrifugal fan (5) according to any of the preceding Numbered Paragraphs, characterized in that
   the inner wall (19) has a serrated edge (39) on its downstream side (20), with alternating rising edges (40) and falling edges (41) over the circumference (U),
   the rising edges (40) form the deflecting edges (21),
   the falling edges (41) are steeper than the rising edges (40) in relation to the circumferential direction (U).
Numbered Paragraph 13. The centrifugal fan (5) according to Numbered Paragraphs 8 and 12, characterized in that
   each projection (31) forms a rising edge (40) and an adjacent falling edge (41) along the circumference (U) in the section lying in front of the downstream plane (29),
   each indentation (33) forms rising edge (40) and an adjacent falling edge (41) along the circumference (U) in the section behind the downstream plane (29).
Numbered Paragraph 14. The centrifugal fan (5) according to any of the preceding Numbered Paragraphs, characterized in that the deflecting edges (21) extend along a cylindrical surface (42) that is concentric to the rotational axis (R).
Numbered Paragraph 15. The centrifugal fan (5) according to any of the preceding Numbered Paragraphs, characterized in that the deflecting edges (21) are straight, curved, or undulating.

### LIST OF REFERENCE SYMBOLS

1 air conditioner
2 vehicle interior
3 airflow
4 channel
5 centrifugal fan
6 outside
7 filter
8 cooler
9 heater
10 impeller
11 housing
12 intake channel
13 deflection chamber
14 outlet channel
15 intake side
16 outlet side
17 flow guidance disk
18 outer wall
19 inner wall
20 downstream side
21 deflecting edge
22 angle of inclination
23 guide blade
24 leading edge
25 trailing edge
26 edge start
27 edge end
28 upstream side
29 downstream plane
30 upstream plane
31 projection
32 end
33 indentation
34 starting section
35 axial spacing
36 axial length
37 height
38 depth
39 serrated edge
40 rising edge
41 falling edge
42 cylindrical surface

1-15. (canceled)

16. A centrifugal fan for generating an airflow for an air conditioner for a vehicle interior, comprising:
has an impeller that rotates about a rotational axis (R) and a housing for the impeller,
the housing comprises an axial intake channel leading to the impeller,
the housing further comprises a deflection chamber encircling the rotational axis (R) at a distance thereto, encompassing the impeller along the circumference (U),
the housing further comprises an axial outlet channel encircling the rotational axis (R) at a distance thereto, axially adjacent to the deflection chamber,
the intake channel is upstream of the impeller and the deflection chamber is upstream of the outlet channel,
the impeller is upstream of the deflection chamber such that when the centrifugal fan is in use, an airflow is propelled radially into the deflection chamber by the impeller, and flows from the deflection chamber into the outlet channel,
the outlet channel is delimited on the outside by a circumferential outer wall and on the inside by a circumferential inner wall,
the inner wall comprises a plurality of deflecting edges along the circumference (U) on the downstream side facing away from the deflection chamber, which are slanted in relation to the circumferential direction (U).

17. The centrifugal fan according to claim 16, further comprising a plurality of guide blades in the outlet channel along the circumference (U), each of which has a leading edge facing the deflection chamber and a trailing edge facing away from the deflection chamber,
wherein each guide blade has a dedicated deflection edge,
and the deflection edges start between the two trailing edges of adjacent guide blades and end near one of these trailing edges.

18. The centrifugal fan according to claim 17, wherein the deflecting edges extend to the trailing edges of their respective guide blades in the circumferential direction (U) along the upstream side thereof.

19. The centrifugal fan according to claim 17, wherein the deflecting edges are slanted in relation to the circumferential direction (U) in the direction of a straight line (G) that connects the leading edge to the trailing edge of the respective guide blade on the inner wall.

20. The centrifugal fan according to claim 17, wherein the trailing edges of the guide blades lie in a downstream plane, at least on the inner wall, and the inner wall has an axial projection for each deflecting edge on the downstream side thereof, which protrudes axially over the downstream plane near the respective trailing edge, and forms at least an end section of the respective deflecting edge.

21. The centrifugal fan according to claim 20, wherein the projections are triangular, wherein the corner axially spaced apart from the downstream plane is rounded.

22. The centrifugal fan according to claim 20, wherein the projections extend on both sides of the trailing edges along the circumference (U).

23. The centrifugal fan according to claim 20, wherein the inner wall comprises an axial indentation for each deflecting edge on its downstream side, which is between the two trailing edges of two adjacent guide blades, axially behind the downstream plane, and forming a starting section of the respective deflecting edge, and the deflecting edges are formed by the starting sections of the indentations and the end sections of the projections.

24. The centrifugal fan according to claim 23, wherein the indentations are triangular, wherein the corner axially spaced apart from the downstream plane is rounded.

25. The centrifugal fan according to claim 17, wherein the leading edges of the guide blades lie in a upstream plane, at least on the inner wall, the axial length (36) of the deflecting edges is 40% to 60% of the axial spacing between the upstream plane and the downstream plane.

26. The centrifugal fan according to claim 25, wherein the axial extension of the projections is 25% to 35% of the axial spacing, the axial extension of the indentations is 20% to 30% of the axial spacing.

27. The centrifugal fan according to claim 16, wherein the inner wall comprises a serrated edge on the downstream side thereof, with alternating rising edges and falling edges over the circumference (U), the rising edges form the deflecting edges, and the falling edges are steeper than the rising edges in relation to the circumferential direction (U).

28. The centrifugal fan according to claim 23, wherein each projection forms a rising edge and an adjacent falling edge along the circumference (U) in the section lying in front of the downstream plane, and each indentation forms rising edge and an adjacent falling edge along the circumference (U) in the section behind the downstream plane.

29. The centrifugal fan according to claim 16, wherein the deflecting edges extend along a cylindrical surface that is concentric to the rotational axis (R).

30. The centrifugal fan according to claim 16, wherein the deflecting edges are straight, curved, or undulating.
